(19) United States
(12) Patent Application Publication
(10) Pub. No.: US 2013/0254002 A1
(43) Pub. Date: Sep. 26, 2013

(54) SYSTEM AND METHOD FOR OFFERING AND FULFILLING OFFERS ASSOCIATED WITH A RECIPIENT PAYMENT AND DELIVERY ACCOUNT

(71) Applicant: GIFTYA LLC, Pittsburgh, PA (US)

(72) Inventors: Thomas M. ISAACSON, Huntingtown, MD (US); Virginia T. ISAACSON, Huntingtown, MD (US)

(73) Assignee: GIFTYA LLC, Pittsburgh, PA (US)

(21) Appl. No.: 13/788,813

(22) Filed: Mar. 7, 2013

Related U.S. Application Data
(60) Provisional application No. 61/615,561, filed on Mar. 26, 2012.

(51) Int. Cl. G06Q 30/06

(52) U.S. Cl. CPC G06Q 30/0641
USPC 705/14.23

(57) ABSTRACT

A system, method and non-transitory computer-readable storage medium are disclosed for one-click purchasing via a mobile device based on situation information of a user. A system associates a product with the user and a registration profile that includes a user payment and delivery account (registration profile) at an on-line shopping environment. The system transmits an offering to a device of the user that includes a presentation of the product and an indication that the user can purchase the product via interaction with the offering. The system receives an indication of the purchase via interaction with the offering and the purchase is completed using the payment account and delivery is accomplished either physically or to an electronic device destination based on data in the registration profile. In one embodiment, one-click gift purchasing for a contact via a mobile device is disclosed.

### PRIORITY

The present application claims priority to Provisional Application 61/615,561, filed Mar. 26, 2012 (Attorney Docket 088-0102-Prov), all of which is herein incorporated by reference.

### BACKGROUND OF THE INVENTION

1. Field of the Invention

This invention is related to the field of offering products or services for purchase to consumers, and more specifically to associating a payment and delivery processing account of a recipient to an advertisement to the recipient to generate an offering that the user can interact with, in a single interaction, to purchase and have the product delivered.

2. Introduction

Associating advertisements with payment accounts such as a Visa or a Mastercard is known. These advertisements are generated in such a way that the recipient does not have to even interact with the advertisement but can merely receive an advertisement with a coupon that offers 10% of an item such as a book or a meal at a restaurant. The prior art systems are designed to then monitor the purchasing activity of the recipient using the payment account that was associated with the advertisement. The system monitors the purchasing activity of the recipient to determine when the recipient shops at the store or purchases a meal at the restaurant. A rebate or coupon is then applied after the sale such that the recipient receives a credit on their payment account.

When the user receives the advertisement via email to buy an item, the user still has to go through the “normal” approach of going to purchase the item at the store or going to a website to buy the item. After the purchase, under either approach, the system detects that a purchase has been made using the payment account and implements the discount with another transfer of money to implement the discount. While this approach can provide the recipient with a simple and known mechanism of making purchases, it has several drawbacks, as shall be explained below.

The above-described approach often expressly does not require the consumer to interact with the advertisement to accept the offer. Such advertisements are designed to urge the consumer to come to a brick and mortar store to make a purchase. The system, after delivering the advertisement, must then monitor the recipient's purchases to identify a completed qualifying purchase. After receiving the advertisement, the user must physically go to a brick and mortar store or open up an internet browser on their device or on a separate computer and navigate to a website to make a purchase using the payment account. Thus, infrastructure must exist to detect that the user has accepted the coupon or the offering by identifying a purchase using the credit or debit card. This infrastructure can be costly to implement and manage.

Other problems with the prior art approach exist. For example, the user may prefer to not receive incentives to physically go to a brick and mortar store for a period of time. A recipient may be home and ill for several weeks in which case an advertisement that urges them to travel to a brick and mortar store will be forgotten and wasteful. Given the pattern of the way people live their lives, an advertisement that urges them to go make a purchase in the normal fashion may not always be timely or desired.

Next, the infrastructure necessary to easily and efficiently monitor payment transactions can only be implemented with great effort and may have privacy and regulatory hurdles to overcome. Consumers may be uncomfortable granting permission to their Visa or Mastercard provider to monitor their transactions and provide purchasing information to a third party. Absent a high level of comfort in the privacy of financial purchases, users may be unlikely to sign up for such a system in that they feel that “big brother” is watching their activity too much.

Further, such systems typically will process a transaction at full price and then provide a rebate on the payment account after the purchase. While a user can later look at a billing statement and recognize that a discount was provided, such information might not be noticed and the marketing impact of the advertisement can be lost. Furthermore, the extra costs and complexity of processing a completely separate transfer of money from one account to another can be daunting and costly.

The prior way of pre-associating advertisements simply with a credit card also introduces difficulties where the knowledge of a particular purchase at a point of sale using a visa credit card or debit card is proprietary information. Therefore, the practical mechanism of a third party receiving such information presents privacy, technical and potentially regulatory hurdles. Accordingly, another mechanism of being able to present advertisements and to process purchases is desired.

What is needed is a simplified way for the recipient of the advertisement to make a purchase without needing to go to the brick and mortar store or navigate to a website and that addresses some of the issues set forth above.

### SUMMARY

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

The following disclosure provides three embodiments that address the issues in the art discussed above. The first embodiment relates to a “product offering.” The product offering focuses on the issue of how to present an advertisement to a user that enables them to easily make a purchase without the need to go to a brick and mortar store or navigate to a website using their ‘normal purchasing’ patterns. This embodiment presents a mechanism that is simpler than the normal purchasing patterns because of the way it is pre-configured. The difference from previous systems is that the advertisement or offering is associated in advance with an existing payment and delivery account such that the user can interact with the offering directly and purchase the item and have it automatically delivered. Any discounts can be directly applied without the need to engage in another financial transaction to accomplish the discount.

An example of the prior approach illustrates the benefit of the above advance in the art. Assume a user receives an advertisement on their iphone that states: “We thought you'd like to buy the book entitled “XYZ” today, if you buy it, we'll give you a 10% discount. Just use your Visa card.” The user then must navigate to a website, start an application to make a purchase, or go to a brick and mortar store to make the purchase. The system detects via the credit/debit card processing that the book was purchased (say for $20) and implements the discount by rebating $2 back to the Visa account used to buy the book. The above process requires extra steps for the recipient that is unnecessary. Because the user still has to go and make the purchase in the “normal fashion”, the user may simply ignore the advertisement offering.

This disclosure addresses the specific issue of requiring a user who receives an advertisement to proceed to a store or navigate to a website and purchase the item advertised. Under the principles disclosed herein, the advertisement is not associated directly with the recipient's credit card. Rather, the advertisement is pre-associated with an on-line purchase and delivery account of the recipient, which can include credit card or debit card payment information (or other payment information such as paypal.) The type of payment account is not relevant. The advertisement in this case will state: “We thought you'd like to buy the book entitled “XYZ” today, if you buy it, we'll give you a 10% discount. Just click on the purchase button below and it will be at your home Wednesday at a discount.” This simplicity is achieved by presenting an offering to the recipient that is as though the recipient had navigated through their on-line purchasing service to the point of viewing the book “XZY” and, with the payment and delivery information already stored in their account, presenting the ability of the user with a single interaction to purchase the item and have it delivered to the address on record.

Thus, a solution to the above-identified problem is as follows. A method embodiment includes identifying, at a first time, a product to include in an advertisement/offering to be sent to a recipient at a second time that is later than the first time. The advertisement is associated prior to the second time with a payment and delivery account of the recipient. This is similar to an on-line shopping environment account that includes payment information as well as delivery information for the recipient. Any such account would apply as long as it has the basic necessary information for managing a payment for the recipient and delivery information. U.S. Pat. No. 5,960,411, and its later issued continuations, continuations-in-part and/or reexamination patent(s), include disclosure of a single click purchasing approach, and the content of that patent is incorporated herein by reference. The payment and delivery account does not have to be a “one click” type of account, but can be any account that the recipient has which can be used to purchase the chosen item. In other words, there may be two different on-line payment and delivery accounts of the user, and the item that is to be advertised may only be able to be purchased on-line using the second account, which does not provide a one-click purchasing option. In that case, the offering would be as though the user had navigated to that account and the processing would continue through that account rather than an account capable of processing a single interaction.

Such payment and delivery accounts are used to achieve the ability of processing a one-click purchase where a user has identified a product and because their payment and delivery information is on record, the user can just one-click and the product will be delivered.

The difference in this case is that the advertisement is preconfigured such that the user does not just receive a notice or an ad, but the recipient receives an offering that is configured and connected to their payment/delivery account. The offering can be received independent of any solicitation or independent of a request for an offering. Thus, rather than just receiving an email, the recipient is presented with an offering that is preconfigured to include the item that is for sale, including any such discounts, as though the recipient had navigated in the on-line shopping environment for the item and only needs to one-click to (1) buy the item and have the stored credit/debit card process the payment and (2) have the service deliver the purchased item to the address of record. Thus, the user can “one-click,” buy the product advertised. This approach addresses many issues in the art such that there is no need for further infrastructure or monitoring purchases—by the time the offering is presented, and any discounts built in, the user just purchases the item using their familiar and known payment and delivery account. The user can immediately make the purchase and the product delivery process can begin.

Merchants can send consumers situation-based and location based offers and use their existing payment and delivery processing system (i.e. credit card processing plus stored address information for delivery) to fulfill the transactions. The “situation” refers to any data that can relate to the current state or situation of a device or a consumer. For example, the situation may be the state of a vehicle (low on fuel) or the situation of a consumer (6 months since your last haircut, or they always buy the latest political book on the president), or the situation of the environment (it rained in New York). Further, the disclosure addresses the payment and delivery processing company's desire to attract customers to use a particular website such as on-line shopping environment. Another advantage is that the system simplifies the fulfillment requirements of the merchants and enables them to refine their promotion offering beyond simply location-based offerings. Since the offer relates to a product that is to be shipped, location does not matter and the merchants can tailor offerings to specific products that users may just want to buy and have shipped.

Embodiments of the invention include systems, non-transitory tangible computer readable media, computer readable media and methods associated with the interaction of presenting offers to users on mobile devices and managing the purchase of items or services based on the offers in a standard manner for the user and the merchant. In other words, the offering places the user in a position as though they had navigated to a purchase point of an on-line service, reducing the number of steps a user must perform to take advantage of an offering. There is no other interaction needed to reach that point.

A method embodiment includes a method of advertising and completing a transaction including receiving situation information at a device. The method includes, based on the situation information associated with a recipient, transmitting an advertisement to a device of the recipient, the advertisement being associated with a payment and delivery account of the recipient. Upon receiving confirmation that the recipient has purchased the product, the system processes the purchase and delivery based on the payment and delivery account data.

In another embodiment, a system, method and non-transitory computer-readable storage medium are disclosed for purchasing a product and/or service as a gift for a contact in a social network via a mobile device using user-based situation information and a one-click purchase option. A system configured to practice the method associates a product and/or service with the user based on situation information of the user including, information related to a contact in a social network and a registration profile having a user payment/delivery account (registration profile) at an on-line shopping environment that manages purchasing and shipping of the product and/or service to the user or to other addresses in the user profile. The system transmits a message, advertisement, offering, or presentation to a device of the user including a presentation of the product and/or service and an indication that the user can purchase the product and/or service related to the contact via interaction with the offering. The system receives indication of the purchase for the contact via interaction with the offering by the user and completes the purchase by the user and delivery to the contact using the payment account and contact address in the registration profile.

The transmitting can be independent of any user solicitation for a communication and independent of a request for, or processing a purchase of the product and/or service. The user can purchase the product and/or service associated with the contact with one-click using default purchase settings such as address information, credit card information, gift wrap information and greeting information or the user can choose to edit the default purchase settings. Information related to a contact can include important events such as an anniversary, birthday, holiday and graduation. Furthermore, a coupon can be associated with the user and processing the purchase can include a rebate to the payment account based on the coupon. A coupon code can be preinserted into the presentation such that the benefit of the discount can automatically be processed if the user one-click purchases the item. The product and/or service can be based on current inventory of a product or service availability and the situation information of the user.

Another embodiment relates to a “service offering.” In this case, there will be no physical object to deliver. Thus, the user payment and delivery account may not need to reference the delivery information. In this case, the recipient account can have a delivery address but it will not be used since no physical product will be sold and delivered. In one aspect of this embodiment, a calendar of the recipient and/or merchant offering the service can be accessed to provide a scheduling component to the offering.

In this second embodiment, the system may retrieve situational information about a recipient and identify a service to be offered for purchase. An example will illustrate the point. Assume that a recipient has not been to the dentist for a cleaning in six months. The system can detect this situation and determine that an advertisement to get a cleaning scheduled would be likely accepted. The system can access the recipient calendar as well as a dentist calendar and the recipient payment and delivery account. A discount can be offered as well. Thus, an advertisement can be generated, using this information, which presents the following offering: “John, you have an opening in your calendar tomorrow at 2 PM and next Monday at 11:00 AM. Please click the appropriate button to purchase a cleaning at your dentist and schedule the appointment.” Buttons can be offered such that in one or two interactions with the offering, the following occurs: first, a payment, or co payment, can be processed such that the service is paid for. This can eliminate the need for processing a payment after the service is rendered. Next, John's calendar and the dentist calendar can be updated to show the appointment is established. Additionally, a discount can be offered and processed at that time. Optionally, John may schedule the appointment but opt not to pay via the interaction but later at the dentist.

A variation of this embodiment is also provided in which a service is to be provided but no scheduling is to occur. Assume John needs a haircut and the local barber wants to give a 10% discount or just advertise to get a haircut. John receives the ad that offers the service that states: “John, we'll give you a 10% discount if you buy a hair cut at Joe's Chop Shop.” John can interact with the advertisement (such as with a single click) to buy the haircut. Since there is no scheduled time, John can get the haircut at any time. To prove that he has already paid for it—the system can utilize location based services to know when John is in Joe's Chop Shop. Some type of image or data can be transmitted to John's device which can be shown to Joe at the store to prove that through this system he has already purchased the hair cut—it can be an image of the day, or a UPC symbol that is scanned or any other type of confirming data to present to Joe that confirms that the purchase has been made. A fingerprint or any other type of biometric can be used as well.

As can be appreciated, this second embodiment enables users to easily process the purchase of a service that ultimately is simpler than the normal way of purchasing it. At the location where the service is offered, there is no need to process a payment since the simple interaction with the offering/advertisement already processed the payment. Only a confirming indicator is necessary.

The third embodiment of this disclosure relates to determining which type of offering to present, a “product offering”, a “service offering” or another type of offering. The system can evaluate the situational information and make a determination as to which offering is preferred. For example, if the user is at home, and not likely to be out near a store where an oil change can be made, then an offering allowing the user to one-click the product may be inappropriate. Otherwise, if the situational information indicates that the user is in a location near a brick and mortar store, then an offering that is tied to a user's payment account which needs to be redeemed at a brick and mortar store may be more appropriate. The system makes a determination of which type of offering to extend to the user based on situational information. A first type of offering would be preconnected to a recipient's payment and delivery account and configured such that interaction with the offering would be processed according to the registration profile with the payment and delivery account. This would typically relate to a product that is advertised that can be delivered to the user. A second type of offering would be connected to the user's payment account and can include reference to a user and a merchant calendar. This second offering would relate to services to be provided and can process a payment and a scheduling or a confirming mechanism that the service has been purchased. Another kind of offering in the determination might be the known type in which the offering is tied to the user credit card and the user continues to navigate to a website or to a brick and mortar store and make a purchase in the normal fashion. In this manner, the appropriate type of offering can be selected by the system for convenience of the user and the likelihood that the user will make a purchase in one way or another.

In another embodiment, various devices at someone's home could be set up to monitor for errors or diagnostic problems. For example, heating systems, air conditioning systems, and so forth. Consider a home having a boiler for its heating system and a sensor indicates that water pressure in the system is low. That data can be transmitted to an on-line system that evaluates the situation. An algorithm can identify one or more questions relative to the problem that can be presented to the owner via an interaction. For example, the system can notify the user and ask if they have cycled the system off and on and to report what the water pressure is. The user can then respond with the information that the water pressure is at the right level—at which point the system can determine the right part that is likely the problem. At this point, the part can be presented in an offering that the user can accept and have delivered to their home.

As can be appreciated, the “situational information” in the previous example can come from diagnostic data for a home or business based device, which can trigger several exploratory questions to ultimately identify a product that can easily be purchased and shipped using the recipient registration profile in an on-line shopping environment. This can simplify repairs and save money in terms of reducing the need for visits by technicians to the home or business.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only exemplary embodiments of the invention and are not therefore to be considered to be limiting of its scope, the invention will be described and explained with additional specificity and detail through the use of the accompanying drawings in which:

FIG. 1 illustrates an example system embodiment;

FIG. 2 illustrates a network according to an embodiment of the invention;

FIG. 3 illustrates a merchant interface for inserting information about products;

FIG. 4 illustrates an example method of the first embodiment;

FIG. 5 illustrates an example offering on a user device;

FIG. 6 illustrates an example method of the second embodiment;

FIG. 7 illustrates an example network according to an embodiment of the invention;

FIG. 8 illustrates an example method of the third embodiment;

FIG. 9 illustrates a fourth embodiment; and

FIG. 10 illustrates an example offering on a user device.

### DETAILED DESCRIPTION

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

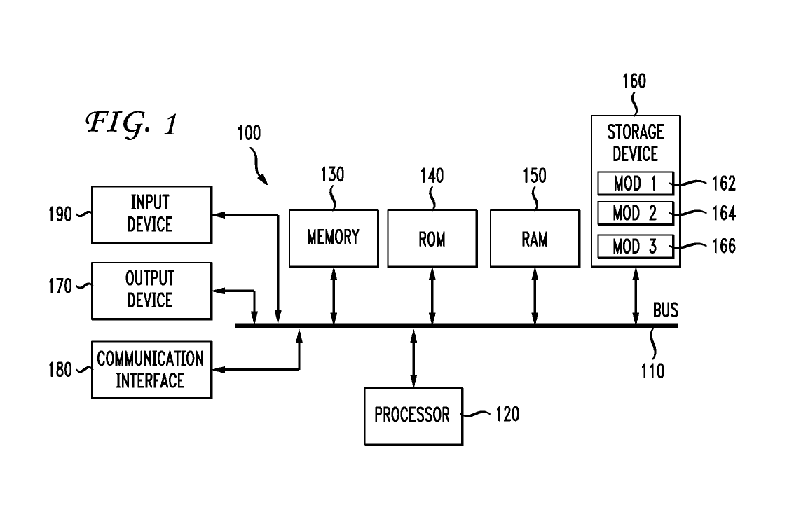

With reference to FIG. 1, an exemplary system includes a general-purpose computing device 100, including a processing unit (CPU) 120 and a system bus 110 that couples various system components including the system memory such as read only memory (ROM) 140 and random access memory (RAM) 150 to the processing unit 120. Other system memory 130 may be available for use as well. It can be appreciated that the invention may operate on a computing device with more than one CPU 120 or on a group or cluster of computing devices networked together to provide greater processing capability. The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices such as a hard disk drive 160, a magnetic disk drive, an optical disk drive, tape drive or the like. The storage device 160 is connected to the system bus 110 by a drive interface. The drives and the associated computer readable media provide nonvolatile storage of computer readable instructions, data structures, program modules and other data for the computing device 100. The basic components are known to those of skill in the art and appropriate variations are contemplated depending on the type of device, such as whether the device is a small, handheld computing device, a desktop computer, or a computer server.

Although the exemplary environment described herein employs the hard disk, it should be appreciated by those skilled in the art that other types of computer readable media which can store data that are accessible by a computer, such as magnetic cassettes, flash memory cards, digital versatile disks, cartridges, random access memories (RAMs), read only memory (ROM), a cable or wireless signal containing a bit stream and the like, may also be used in the exemplary operating environment.

To enable user interaction with the computing device 100, an input device 190 represents any number of input mechanisms, such as a microphone for speech, a touch-sensitive screen for gesture or graphical input, keyboard, mouse, motion input, speech and so forth. The device output 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on the invention operating on any particular hardware arrangement and therefore the basic features here may easily be substituted for improved hardware or firmware arrangements as they are developed.

For clarity of explanation, the illustrative system embodiment is presented as comprising individual functional blocks (including functional blocks labeled as a “processor”). The functions these blocks represent may be provided through the use of either shared or dedicated hardware, including, but not limited to, hardware capable of executing software. For example the functions of one or more processors presented in FIG. 1 may be provided by a single shared processor or multiple processors. (Use of the term “processor” should not be construed to refer exclusively to hardware capable of executing software.) Illustrative embodiments may comprise microprocessor and/or digital signal processor (DSP) hardware, read-only memory (ROM) for storing software performing the operations discussed below, and random access memory (RAM) for storing results. Very large scale integration (VLSI) hardware embodiments, as well as custom VLSI circuitry in combination with a general purpose DSP circuit, may also be provided.

The system description above relates to the basic components of a computing device or other device which may relate to a component of a system embodiment of the invention. Other basic hardware components may also be employed where appropriate. For example, in the discussions below various devices will provide situation information. For example, a vehicle may provide situation information associated with the mileage of the vehicle or how much gas is in the vehicle. The components necessary to both sense the particular situation and transmit the particular state to a separate receiving device may differ from the basic components set forth above relative to a computer. A local store may have a computer system that provides situation information of a listing of customers that have not had a haircut for over 6 months, or not had a teeth cleaning for over a year. An online merchant of books can identify that a user has not purchased the latest book on politics like they normally do. Situation information may also be received from other bureaus and relate to other general information such as when it last rained in particular zip codes. The situation information may be viewed as a filter for the advertisement.

Accordingly, depending on the particular hardware configuration or the various components used to receive and process situation information, the system aspect of this invention may encompass known hardware components depending on the individual type of situation information and individual devices that are interactive to carryout the various functions described herein.

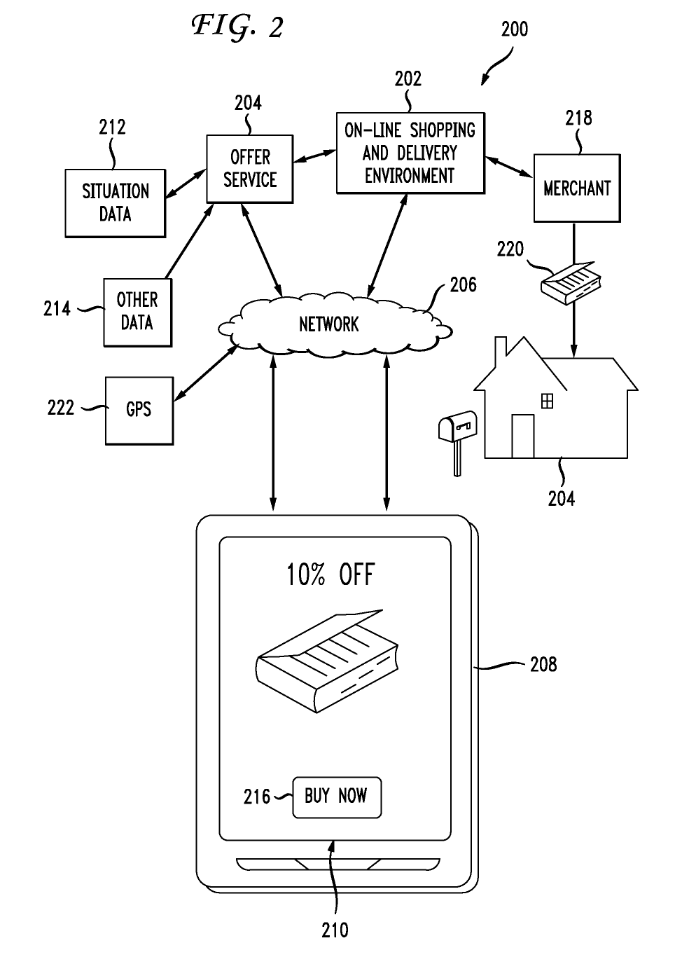

As is noted above, a first embodiment disclosed herein relates to utilizing location and/or situationally-based information to present product offers to consumers on a device which may be a desktop computer, laptop computer, mobile device, smart phone, or any other type of device which may be used to communicate with a user. A general system 200 is shown in FIG. 2. Situation information 212 is shown as originating from a device 210. As noted above, this device may be a car, a computer, a refrigerator, a merchant and so forth. Module 212 can also represent any type of data that might be gathered that is associated with the user. For example, 212 can include previous searches on the internet via a website such as Google, purchases online or via any other website in which data can be gathered. For example, a user might have previously searched an on-line shopping environment for a particular type of lamp. This information can also be social networking data, email or texting data or any type of online interaction that can provide information that can be used to select a type of product or a service as part of an offering to the user. This device is meant to represent any kind of device that has “situation” information that can be communicated to the service bureau or offer service 204. The delivery mechanisms may vary as well. For example, the On-Star® service may be able to provide situation information about a particular vehicle to the service bureau or offer service 204. Various devices may communicate via various protocols to the service bureau or offer service 204 and provide the necessary situation information.

In the first embodiment, the offer service or service bureau 204 receives situational data 212 and utilizes that information to identify a product and a recipient. An example will illustrate the point.

Assume that the situation data 212 indicates that a recipient Mary always buys the latest political book about the president of the United Sates. This information can be identified from online purchases or brick and mortar store purchases that can be tracked. The offer service 204 identifies that there is a new book out about the current president that she has not yet purchased. An offering is generated to allow her the opportunity to purchase the book either at full price or at a discount price. The offering can also be generated based on other information such as whether there is a group of coupon codes available that have yet to be used or if a particular store has extra stock of the book and so forth. Thus, other data 214 may also be provided that can help in generating an appropriate offering. Assume for this example that the offering includes a suggestion to buy a book at a 10% discount. Assume that the book would normally be $20 and with the discount it is only $18. The offer service 204 communicates with an online shopping and delivery environment 202. Assume that Mary is a registered user at the shopping and delivery environment 202. This is similar to Mary having a registration profile, or account at an on-line shopping environment that includes payment data and delivery data for processing single-click purchases. In this case, purchase account information such as a debit card, credit card, PayPal or any other payment account information is registered with a payment/delivery profile. Mary includes in that profile delivery address information. Assume her address is 1234 Center St, Centerville, Md. 21234. This online purchase/delivery account enables her to search and identify products using the environment and when a product is presented that she wants to buy, a “one-click” purchasing option can be available upon which receiving input via a “one-click” button the system automatically processes the purchase through the stored purchase account as well as delivers the product to the stored delivery address. The delivery information can also include electronic delivery information such as Mary's Kindle or iPad or any other device that can receive delivery of an electronic software product, reading product such as a book, a blog, or a news outlet. Thus, in each case where physical delivery of a product is referenced, the delivery mechanism can also be an electronic delivery to a particular device, or delivery to a cloud-based account such as a person's Apple ID account where the person can access the product. In one aspect the advertisement is delivered to one device, and the electronic product is delivered to another device. For example, an ad may be received by Jane on her Blackberry® device where it is preconfigured to deliver an electronic book (the product being advertised) to her Kindle device, because her Kindle device is the electronic delivery device in her registration profile.

The offer service 204 associates a particular offering for Mary with her on-line purchase and delivery account in the environment 202. In this case, the offering will be presented to Mary as though she had searched for the latest book on the president using a search field in the on-line environment 202 and had been presented with the latest book. In other words, the offering 210 would be as though Mary had navigated to a state in which the on-line environment 202, knowing that it was Mary and connecting her to her on-line shopping and delivery account 202, would process the purchase and delivery of the presented product upon receiving her “one-click” acceptance of that product.

Thus, the offer service 204 has associated the product with the purchase and delivery profile of Mary 202 and transmits the offering through a network 206 to a device 208 Mary registered. In a normal on-line purchase, coupon codes can provide discounts at a sale. In this case, the discount code is built into the offering 210 so that the discount is immediately processed with the purchase. Thus the offering 210 shows a 10% off of a book that is preconfigured so that all Mary has to do is click the buy now button 216 and she will receive the book in the mail a few days later.

The offering may be for full price or may provide a built in discount. The offering can be presented in such a way as to already include a discount code as is used in the manual way of navigating to a purchase screen.

As can be appreciated, this approach greatly simplifies the process of actually receiving the book over the prior art. Previously, an offering could be received to buy a particular book at a discount that would only be associated with a payment account. However, to actually make the purchase, the user would have to go to a website, log-in and navigate to purchase the book. In another aspect, the user might have to go to a brick and mortar store such as Barnes and Noble and make the purchase. The simplified approach disclosed herein allows a user to perform a simple interaction with the offering to purchase a product and have the product delivered.

Presenting offerings on a device can be accomplished in a number of ways. Simple text may be used or a listing of offers may be collected and the user can then access the list. In one aspect, the system filters and organizes the offerings for the user such that when they access the list, they are organized and easily viewed. The offerings can also be integrated into a website viewed by the user. For example, they may be presented as banner ads on a website by the user. They can be organized and presented to the user as part of their account on a website where they can easily view the offerings. If the offerings are web-based offers, there can be “single click” purchasing or accepting of offerings available. The particular card used for a single click purchase can be predetermined based on the card company making the offering. Thus, while some single click purchasing websites keep a single card on file to use for the purchase, this disclosure provides a contrast where there may be a number of cards available and the card used is the one that has processed the situation information and is willing to provide the discount for the purchase. The user may call a service and receive an audio listing of the offerings. They of course may appear on a mobile device. In one aspect, whatever form the interaction is for the user, the interaction will inform the user regarding which card to use to obtain the discount. For example, the interaction will say or present data informing the user to redeem the offer by clicking on the site and it will process the purchase using their visa card in the profile. The interface may present a button to click to redeem with visa, or another button to click to redeem with mastercard. The user payment/delivery profile can include both payment accounts and thus the system needs to distinguish between the two. The advertisement generally speaking will include instructions on how to purchase the item. The ad could be an audio ad presented to a particular user and the user can respond via voice in the affirmative, i.e. “yes” to have the advertized product or service delivered.

For example, if the user is listening to radio on their hand held device, the audio ad can make a presentation such as “Mary, good morning. This ad is connected to your Amazon.com account. You can purchase the book and have it delivered.” The system would receive voice interaction from the user which is akin to a “one-click,” then the system can charge the recipient's payment account and deliver the book in the fashion disclosed herein. In this case, a two way audio communication is valuable. Additionally, the listener can press a button or provide some other “yes/no” indication to make the purchase in response to the audio ad. If the audio is heard as part of a telephone call such as a caller listening to an audio broadcast on a call, the system can include two way communication ability such that the user can respond by speaking. In other words, capabilities exist for a user to make a phone call to connect to an audio broadcast. This approach enables two-way audio communication. Typically, a listener would just listen to the broadcast, however this approach allows insertion of an audio advertisement into the broadcast for a particular user. The advertisement is preconfigured to the listener's payment and delivery account such that a listener can make a purchase via a simple audio feedback communication. The feedback does not necessarily have to be delivered via a telephone call. If a data network is delivering the audio broadcast to a device such as mobile, laptop or desktop, software or hardware can be configured so that the device also includes a microphone capability. The device can be turned on to receive a user indication in response to the audio advertisement, for example that they desire to purchase the product and have it delivered. The system can have sufficient automatic speech recognition capability to recognize the user audio input as affirming that they want the product or service. In this aspect, where elsewhere in this disclosure an advertisement is generated and delivered, in the audio aspect, an audio version of the advertisement can be constructed and a timed delivery provided. While the user is listening to a program, the audio ad tied to their payment and delivery account can be audibly delivered, and the system can receive audio, button-press or other type of input to confirm the purchase for delivery. If the audio advertisement is for a service where additional data is needed, such as a confirmation of a time, then the system can engage in a brief spoken dialog with the recipient. The ad in this aspect can make a presentation such as, “Mary, I have 20% off on a tooth cleaning at the dentist. Both your calendar and the dentist's calendar show two openings, tomorrow at 2 PM and Friday at 11 AM, say “yes” if you want to go and say the time that works for you.” The user then only needs to say “yes” and “11 AM” or “11” and the system processes payment for the cleaning and scheduling the appointment in one or both of the user's and the dentist's calendars. If the audio is streaming audio to a device and there is no convenient audio feedback mechanism, the audio ad can be coordinated with a display screen such that the audio is heard and an opportunity to provide an indication of acceptance of the offer can be provided to the user via a screen or other input such as a button press: “press 1 to accept this offer.” Any acceptance mechanism will do. A confirming email with an opportunity to cancel the acceptance can also be sent after the initial original acceptance.

In another aspect of this disclosure, a user can register various devices providing data relating to an advertisement. In this aspect, the service bureau 204 can develop a record and maintain improved situation information for the user. If a user registers a vehicle, a home computer, appliances such as a dishwasher and refrigerator and a mobile device, then situation information can be received and coordinated. If the car transmits situation information that it is low on oil, and the situation information from the mobile device indicates that the user is in the vicinity of the auto mechanic, then that combined situation information acts as a filter to help trigger an advertisement from the auto mechanic for an oil change.

For example, if a particular sensor in a heater is bad the system can identify a replacement part, generate an offering that includes the replacement part in which the offering is preconnected with the owner's purchase and delivery account in the online delivery account 202 and send an advertisement or an offering to the user. Other information can be presented as well, for example the offering can state an error code for their boiler system that indicates that water pressure might be low. The issue might be a problem with the water pressure sensor. The offering would include a replacement sensor and the user can read about the issue, look at the part and if it is desirable to order the part, the recipient needs to only interact via one-click or several clicks to purchase the part and have it delivered. In this manner, the situational information can provide more data about the underlying situation rather just providing an item for purchase. The offering can include other data 214 regarding the offering trigger including reasoning as to why the user should make the purchase.

The group of devices registered for the user may also enable the coordination of the situation information to further filter and identify advertisements. The user can have the opportunity to manage the level of situation information provided. For example, the user may indicate that they want to receive the situation information of the vehicle regarding its gas level and oil level but not its location. If a doctor or dentist registers to provide situation information, the user may restrict the information to be the number of months since their visit and not any information about the nature of the last visit. Thus, the registration process is used to provide control to the user regarding the level of granularity of the situation information. An easily accessible website is available for the user to add or change situation reporting data on a device or entity by entity basis. This model is based on pushing information from each registered device or entity to the service bureau 204. A pulling model is discussed next.

Assume a user has not registered any devices or entities with the service bureau but would like to receive special offers. In this case, an embodiment covers the ability of the user to pull an advertisement and dynamically provide situation information to receive advertisements. A user may call or access the system in any manner and provide their location and other situation information and receive offers. Such offers can be organized and preconfigured with an item or service that utilizes the situational information and any other data a user might access that might provide, the connection associated with their on-line purchase profile. A user may provide, for example, their location and the fact that they are low on gas via a phone call, an interaction with a browser on a mobile or desktop device or any other device. They can provide a zip code (whether they are in the zip code or not) and their desired product, type of product or service. In another aspect, the user may have one or more registered devices but may want to provide additional situation information. Therefore, this aspect enables the user to supplement existing situation information. For example, if the user is going to take a long drive and the situation information for their vehicle has not yet sent data indicating that they are low on fuel, the user can override or supplement this situation information and receive offers based on that data. The affinity of the advertisement algorithms may also be adjusted based on this dynamic user input to generate offers to the user where otherwise, based on passively received situation information, the system may not send any offer. Therefore, the system may operate in a fully push mode (automatic situation information generates ads), a fully pulling mode (the user provides manually all situation information) or a hybrid mode where a combination of pushed data and pulled requests are used to generate offers.

In another example, situation information includes environmental information, information about external objects, and/or situation information regarding a level of gas in a user's vehicle from a source 212. The situation information may be gathered from several different places such as over the internet, over a plug-in or wireless communication with the vehicle communication unit while the vehicle is in the user's garage or elsewhere, and so on. Situation information also can include the location of the user or user device 208 via any mechanism such as their GPS 222. The particular manner in which situation information is provided is independent of the concepts disclosed herein and many mechanisms may be known by those of skill in the art for gathering situation information. In this example, assume that the situation information also exists regarding the location of the user in the vehicle. Once this particular situation information is received, the system presents to the user via one or more user devices 208 or via a device in the vehicle an offering indicating that the gas tank is low and that the consumer is within a few miles of a merchant 218. A card such as a credit card or club card as part of a user purchase/delivery account is already associated with the advertisement. This connection of the account with the advertisement or offering enables the simplification of the realization of rebates, discounts and so forth while allowing the user to purchase the item immediately via one-click. An option could be presented where if the user does not one-click purchase the item, the item is still connected to their credit card for a later, “manual” purchase. For example, the offering may present a book for the user to purchase via one-click using their purchase/delivery account with a 10% discount. However, the user may not be sure that they want the book at that point. The user may be presented with another button that allows them to say “Not right now” but allows them to continue to monitor the user's purchases made with a credit card. In this case, if the user then later decides to make the purchase, at a brick and mortar store such as Barnes and Noble, the discount can still apply because the purchase can be associated with the offering.

Another aspect is to utilize also the situation information from the external source 214. Here, the system may know that the last car wash purchased was 6 months ago and also may receive situation information that it rained in the local zip code where the user lives and works and drives. Location information may indicate that the vehicle was not in the garage during the rain storm. Therefore, the situation information may be combined with other situation information to filter the offers.

In another aspect of this embodiment, other intelligence can be provided to the server 204 from an outside source 214 of other state/situation data. Examples of this type of data can be information identifying the weather, the time, current events, and so forth. For example, if it is known that a sports event, such as the Super Bowl, is being played that weekend, there may be particular types of advertisements that can be coordinated for the various stores. In another example, if it is known that the weather is going to be inclement that weekend, then specific offers can be provided to users to purchase specific products to prepare for bad weather. In another aspect, utilizing both inventory information for Store 1, as well as environmental data or other data regarding the weather, the system 204 can improve customer relations by providing offers to users of available products. This may be, for example, if prior to the arrival of a storm, Store 1 runs out of bread or milk. Similarly, if Store 5 is a video store, and a number 1 rated movie is completely checked out of the store, then users approaching the store may receive notifications that a certain movie only has one copy left. An offer can be presented that notifies them that there is only one copy of the movie left for rent. Because the offer is connected with their payment/delivery account, they can have the opportunity to pay a premium and thereby reserve the movie for pick-up at the store. In this way, the merchant can receive higher income and customers can pay a premium to reserve the movie that they want. This can improve customer care inasmuch as users do not arrive at the store and then become frustrated when the movie they desire is unavailable. Another benefit for the merchant is that the purchase is already made by virtue of interaction with the offer prior to the customer coming to the store. Of course, user personal data may be gathered and utilized in making special specific offer decisions. For example, rental histories, purchasing histories and so forth may be gathered and used in the analysis of when it is appropriate to present a specific offer to a user. A web interface is provided in association with another aspect of the disclosure set forth below with regards to appointments or time slots for service providing merchants.

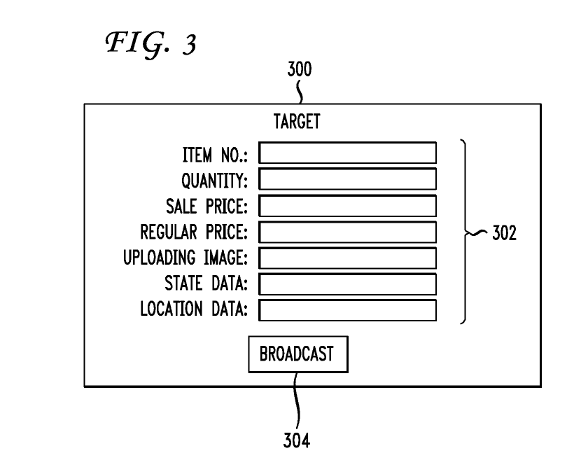

FIG. 3 illustrates an interface 300 which relates to an embodiment associated with a merchant being enabled to utilize a web interface to insert information about products that they would like to sell. For example, the merchant store 218, such as Target, may have a particular product that they would like to sell that day and perhaps provide a discount price. Here, a manager or other worker may navigate to the interface 300 on the internet and simply enter in information in various fields 302 such as the item number, quantity, sale price, and the regular price. Also included is an opportunity to upload an image of the particular product. Of course, as would be known in the art, various fields may be pre-populated to enable a simple insertion or identification of this information. Furthermore, this information may not be manually entered but may be automatically identified and populated in such an input field. For example, this approach may be where products that have been in the store for more than four months may be identified and put into this database as candidates for targeted advertisements according to the principles disclosed herein. A button may be presented 304 which, in the manual aspect, may enable the manager to broadcast the sale. Then, once this information is entered into the database, then the service bureau can intelligently match the products with users and their purchase/delivery profile based on the situation information about their location, state of devices such as vehicle or home products, purchase history, any other relevant attributes, and so forth. Users are identified as candidates and then receive the offerings. In this case, as is disclosed herein, an advertisement is associated with that user's purchase/delivery profile and then transmitted to the user via the mobile device or another device as is disclosed above. Under this approach that differentiates from a previous approach, the user actually purchases the item via interaction with the offering and the merchant then can process that purchase in the normal fashion as they would any other on-line one-click purchase and delivery. After the purchase, the merchant can send the item 220 via mail, FEDEX or other delivery service to the recipient at the stored address 224.

In another aspect of FIG. 3, a merchant can control situation information and the scope of their broadcast. For example, fields such as a situation data field and a location data field are provided that enable a merchant to choose the structure and scope of the offering. Because the products are those that are to be delivered via UPS, FedEx or any other normal delivery service, the merchant may be able to choose the offering such that it only covers recipients having recipient addresses in their purchase/delivery profiles that are local or that particular merchant can personally deliver. For example, a local pizza restaurant that delivers may broadcast a special of two pizzas and a drink for anybody within their delivery zone. In this respect, a correlation can be made between delivery zone and the addresses available in user purchase/delivery profiles such that the one-click purchases can only be made for two users who happen to live within that delivery zone. Furthermore, location based information can verify that users are home at the time.

The merchant may desire to provide a small discount on oil changes that should go out to vehicles that have not had an oil change in over a year for those in zip codes within a radius of 10 miles to the store. This merchant-selectable filter can be input over a web-based interface by a merchant. In another example, assume a national car wash service desires to provide an offering. The entity can limit the offering to locations (such as zip codes) where it rained heavily over the past two days. With respect to car washes, the offering which may be offering a service, can provide the user with the ability to purchase the car wash via the one-click and receive the code for entering the car wash. In other words, this can simplify the overall process of purchasing a car wash. Typically, a user enters an automatic car wash using coins or their credit card to make the purchase. In this case, rather than needing to get out their credit card, they can simply pre-purchase the car wash via the offering interface because it was associated with the user purchase/delivery profile. The system can present to them a code needed to gain entry at the car wash. To make the code easily available, the system can next use location data based services to identify which user device is actually at the car wash, and then present the code such that they do not have to search around for the code. This can make purchasing car washes in this manner extremely simple. Thus, external information from a source may be provided as situation information with the location being also selected by the merchant. Default values can pre-populate fields as well. Variations on this concept of course are contemplated to provide the merchant with flexibility in structuring the offerings.

In yet another aspect, the merchant may set up accounts or triggered offerings. Here, the national car wash service may utilize an interface to establish an automatic triggering of an offering for those living within 30 miles of a business site after reports of rain or snow. Triggers may be established for those who have not come in for a car wash for 6 months at a certain discount and if they still do not come in after 9 months another discount. Additionally, the merchant can set up a triggered offering when inventory of one or more products meets a certain threshold. The merchant can provide details of their inventory for showing in the advertisement extended to the user. The merchant can therefore establish, based on their business model, history of sales, inventory and services in a community, and so forth, targeted advertisements using the various situation information that is available through the principles disclosed herein.

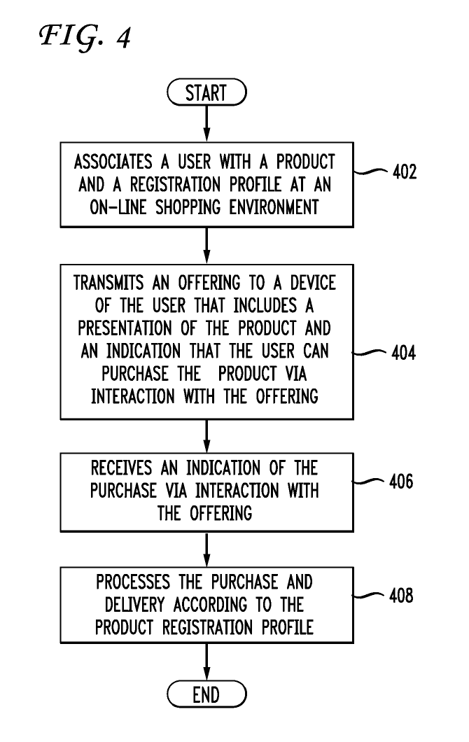

FIG. 4 illustrates an example method embodiment for one-click purchasing via a mobile device based on situation information of a user. A system configured to practice the method associates a user with a product and a registration profile at an on-line shopping environment based on situation information of the user (402). The on-line shopping environment manages purchasing and shipping of the product to the user. The system transmits an offering to a device of the user including a presentation of the product and an indication that the user can purchase the product via interaction with the offering (404). The transmitting can be independent of any user solicitation for a communication and independent of a request for or processing a purchase of the product. The offering places the recipient in the same navigational position as though they had selected the product at an on-line shopping environment at which they are registered. Thus, the user is in familiar territory and can either purchase the product or even continue to shop in the on-line environment. In an audio offering, the information explains what the product is and that the user just needs to say something or press something to accept the offer and buy the product. The audio advertisement may only have 30 seconds within which to deliver the advertisement. There must be some time to interact with the user, so such an ad might be tailored so that it is 20 seconds leaving 10 seconds for the spoken dialog with the user. The ad may say “you have 10 seconds to respond before the program begins, do you want the dental cleaning at 11 AM?” Thus, in each place where the offering is referenced herein, the offering might be an audio offering that the listener can interact with in some way. Then the system can receive an indication of the purchase via interaction with the offering (406) and the purchase and delivery can be completed using the payment account in the registration profile (408). At this stage, the transaction is handled by the online merchant. The sale and delivery is being managed by the online merchant where the user is registered.

A system can associate a product such as a laptop computer with a user and a registration profile stored in a database based on situation information of the user. The registration profile can include a user payment account and address of the user at an on-line shopping environment that manages purchasing and shipping of the laptop computer to the user. Situation information can include any information about the situation of the user such as location, time since an event, weather and financial status of the user, for example. The associating of the laptop with the user and the registration profile can occur when the user is browsing products at the on-line shopping environment automatically. For example the on-line shopping environment can track products the user browses and can make an association based on number of times the user browsed the same or similar products in a period of time or the environment can automatically associate the user with the product in any other way. The association of the laptop with the user can occur based on past related purchases such as desktop computers, tablet devices and smartphones. The user can manually associate himself with the laptop at the on-line shopping environment via a wish list or any other way.

The system 100 can transmit an offering to a mobile device such as a smartphone of the user after the system associates a product such as a laptop with the user and the registration profile. The offering can include a presentation of the laptop that is associated with the user and registration profile and an indication that the user can purchase the laptop via interaction with the offering. For example, the system can transmit an offering to the user via the smartphone based on situation information, such as location, that the laptop is offered at a reduced price for a certain period of time. The system can use the user's current physical location for example at a Best Buy in Columbia, and extend an offer for a discount on a laptop at BestBuy.com that is valid for several hours. Alternately, the system can use the user's current physical location to extend an offer for a competitor's product. For example, the system can extend an offer for an Apple computer through the on-line shopping environment when the system realizes that the user is potentially browsing laptop computers at a Best Buy. The system can receive an indication of the purchase via interaction with the offering and then process the purchase and delivery according to the registration profile 408. In this case, while the user is at Best Buy, the offering might include a discount to purchase a similar electronic product at a discount price for delivery to their home which offer can be accepted by a one-click purchase.

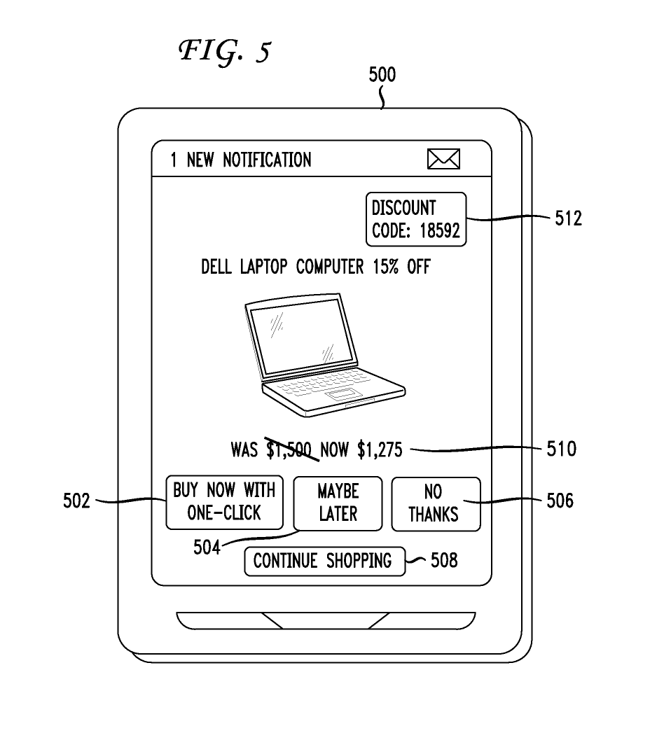

FIG. 5 illustrates an offering on a smartphone 500 associated with a user and a registration profile for the user presenting the laptop previously associated with the user for sale. The smartphone 500 displays a message 510 offering 15% off of the price for the laptop previously advertised and provides an option to purchase the laptop at the time the offering is displayed on the smartphone 502, at a later time 504 and not to purchase the laptop at all 506. If the option to purchase the laptop later is selected 504 the system can wait a predetermined amount of time for example one day and re-offer the laptop at the same or different price than offered in the original offering. If the user accepts the invitation to purchase 502 the laptop based on the offering, the purchase can be completed using the payment/delivery account in the registration profile associated with the user.

When the user accepts the offer, the user need only click once, on the “BUY NOW WITH ONE-CLICK” 502 button for example, to complete the purchase of the laptop. The offering displayed in FIG. 5 is purely exemplary and any message format offering a product for sale is contemplated. Another optional feature is that a discount can be offered as a discount code 512 that is pre-inserted into a field. Often purchasers of on-line products may receive or have a discount code that they include in the processing of their purchase. The discount code can also be associated with the offering and inserted into an appropriate field in the offering 510 so that the user recognizes that they are getting a specific discount to purchase the item.

The purchase is completed using the information in the registration profile which can include default payment and shipping options. The user can change payment and shipping information however storing default options allows the user to purchase the laptop with one-click from a mobile device. Providing the option to purchase a product or service with one-click utilizing payment information stored for the user is an efficient use of resources and frees the user from typing in shipping and payment information each time the user makes a purchase from the same on-line vendor.

Additionally, the system 100 can associate a coupon with the user which can be stored in the registration profile for the user or can be applied in another manner. The coupon can be applied prior to a purchase to yield a discounted price for the user or the coupon can be applied after a purchase as a rebate to the payment account in the registration profile. For example, the system can associate a user with laptop computers because the user has browsed laptops at an on-line shopping environment recently, and can store a coupon for a particular laptop in the registration profile. Should the user purchase the laptop corresponding to the stored coupon, the system can apply the coupon automatically during the purchase or can apply the coupon after the purchase in the form of a rebate to the payment account. Providing the option to use coupons directly or in the form of rebates can encourage users to purchase products offered through messages.

The system 100 can present a product and/or service to the user based on current product inventory or current service provider availability and the situation information of a user. For example, the system can offer a laptop computer to the user based on current product inventory when the inventory is too high for a particular on-line store. This method can be beneficial to a merchant when trying to rid itself of inventory for space requirements or for any other reason, such as expiration date. For example, an on-line grocery store can transmit an offering to the user via his smartphone indicating that there is an overstock of canned chicken. Based on user preferences optionally stored in the registration profile associated with the user, the store knows user is interested in canned foods, such as chicken. The user can purchase the canned chicken via one-click using the default purchase options on his smartphone, allowing a smooth and seamless purchase process. The on-line store can ship the purchased canned chicken to the user using the default address.

Another feature that provides an additional benefit to users is that the offering 510 shown in FIG. 5 can also include a “continue shopping” button 508. In this case, because the offering 510 represents a similar state for a user in which they had navigated for items such as laptops and had arrived at a point at the on-line interface where all they had to do was to perform a “one-click” and purchase the item, additional advantages can be offered in the interface shown in FIG. 5. Specifically, this aspect of the disclosure involves simulating or creating the results of a search which could have been performed by the user prior to arriving at the one-click purchase screen shown in FIG. 5. In other words, if a user had normally been searching an on-line shopping environment for a laptop computer, they could have typed in the word laptop computer. Other fields may have been entered to include a range of pricing. In response to that search, the system would have presented a series of laptop computers that would have matched the search fields. Then, the user would have selected one of the items for further detailed study, at which point the user could perform a single-click and purchase that item. The “CONTINUE SHOPPING” 508 feature of FIG. 5 can simulate that prior search. In other words, the system receives an identification of a product and includes that product in the offering. The system can also recreate search results that include a plurality of products and if the user presses the “CONTINUE SHOPPING” 508 button, the user can instantly be within the on-line shopping environment and continue shopping for similar products. In this case, it is the equivalent of the user having gone to an on-line shopping website, typed in “laptop computer” and viewed the search results. The great benefit of this approach is that via an unsolicited advertisement or offering presented to the user, they can immediately be placed into an on-line shopping environment that is particularly tailored to a product that they are likely to want to purchase. By providing the “continue shopping” option, the user can instantly also be able to see other comparable items with all of the benefits of the standard on-line shopping experience that they are familiar with. Thus, the overall approach disclosed herein provides a particularly easy mechanism of placing users within an on-line shopping environment that is very easy for them to browse and make purchases that are automatically sent to their home.

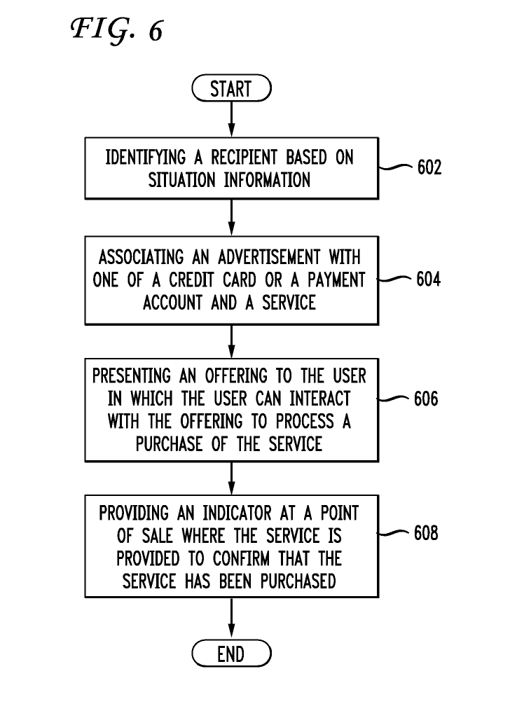

FIG. 6 illustrates another embodiment of the disclosure in which the system determines what type of offering to present to the user so as to maximize the probability that the user will make a purchase. This second embodiment relates to processing the purchase of a service that cannot be delivered like a product can.

The method includes identifying a recipient based on situation information (602) and associating, based on the situation information, a payment account of the user with a service (604) and presenting an offering to the user to purchase the service (606). Once the service is purchased, the system provides an indicator at a point of sale where the service is provided to confirm that the service is purchased (608). For example, when the purchaser goes to get the haircut or to the dentist and a location based service identifies that they are there, the system can present the picture of the day or the user can scan a fingerprint to confirm that service was previously purchased.

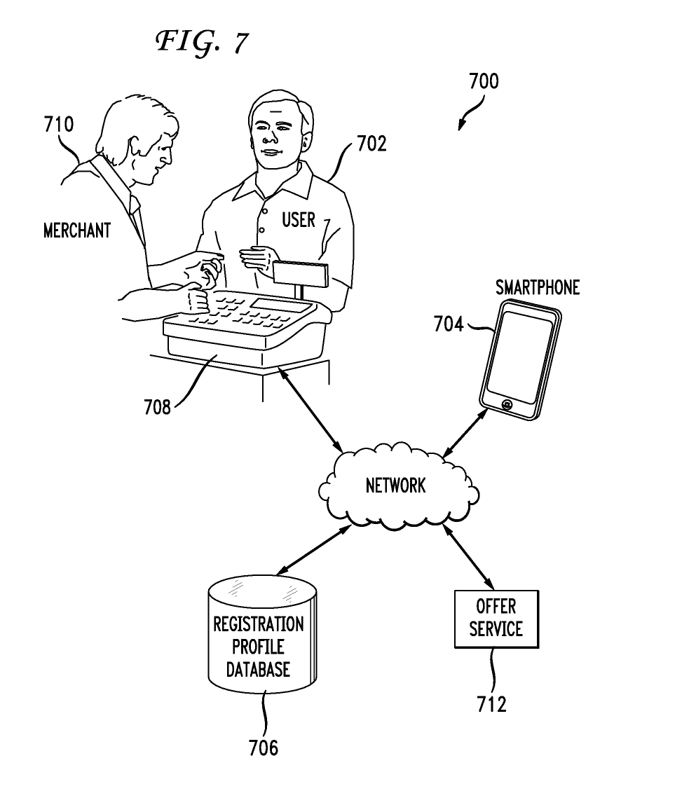

An example illustrates this second embodiment in FIG. 7. FIG. 7 illustrates an example network configuration 700 for one-click purchasing via a mobile device based on situation information of a user. The example network for use by a user 702, includes a user of a mobile device 704, such as a smartphone, laptop, PDA, etc. capable of receiving an offering that includes a presentation of a product and/or service, a product or service for sale such as a laptop or data backup service, a registration profile related to the user 702 stored in a database 706 and a merchant 710 such as an on-line shopping environment. The network illustrated in FIG. 7 can include additional nodes such as users, mobile devices, contacts in a social network, merchants, profiles and products. For example a network with twenty contacts in a social network or five merchants is possible. Additionally, a network for one-click purchasing via a mobile device based on situation information of a user can be dynamic in nature having network nodes added and removed. FIG. 7 is purely exemplary and any network configuration is contemplated.

The system 100 can transmit an offering to the user 702 via a smartphone 704 offering him a discount on a haircut at a local barber salon on a particular Tuesday afternoon, when business is typically slow. The system 100 can utilize user preferences stored in the registration profile 706 associated with the user to associate a haircut with the user. The user 702 can purchase the service with one-click via his smartphone 704 and system 100 can complete the purchase using the stored payment account in the registration profile 706. The user 702 need only to show up at the barber 710 at the appointed time for the service (or at any time), having prepaid for the service in advance. In this regard, since the item purchased is a service, there is no delivery that is to be done. A merchant system 708 can receive fingerprint data and communicate with the offering service 204. At the point of sale where the service is provided, the user only needs to provide a fingerprint or show an image or UPC stored on their smartphone 704 to confirm that the purchase occurred. This is simpler than the normal way of purchasing the service. Any mechanism for proving that the purchase has been made can be used.

A simplification of the approach in the context of a service can take the following form. While the offering is associated with a user purchase and delivery account, the offering in the case of a service that is schedulable can also incorporate the user's calendar. In this case, the registration profile at an on-line shopping environment as disclosed herein, can include access to the user's calendar. This can be presented as part of the “other data” 214 shown in FIG. 2. Thus, if a hair salon, dentist or doctor has openings in their schedules, then they can utilize a merchant portal to report the openings in their schedule, including offerings of discounts to fill in those gaps in their schedules. The system can identify that information and utilize location based or calendar based information for the doctor for registered or even non-registered users that might want to come into the salon for a haircut. In this case, the offering that is presented not only enables the user to purchase the service but also can confirm, even via one-click, acceptance of the offer, purchasing the service and confirming the time for scheduling and receiving the service. In this regard, the “one-click” option may cause the recipient's credit card to be charged $30 for the haircut, while instantly confirming a 2 PM appointment the following day on both the user's calendar and the merchant's calendar. This clearly provides a mechanism in which one-click reduces the need for the merchant to make phone calls, for the merchant to actually process the payment while at the salon or doctor's office and makes the entire process much easier for all parties. The confirmation of the purchase can be highlighted on the merchant calendar so no confirming information needs to be provided by the user in this case. Therefore, in this regard, processing the purchase according to the registration profile can include a calendaring component that is an alternate to delivering a product. As such, this can greatly simplify the entire process in that scheduling and purchase confirmation can be combined.

A method includes, based on a situation information of a user including physical location of the user, associating, at a first time and via a processor, a service with (1) the user, (2) the location and (3) an existing registration profile that comprises a payment account of the user at an on-line account that processes purchasing services by the user. Next, the method includes transmitting an offering to a device of the user, the transmitting being at a second time which is later than the first time, and the transmitting being independent of any user solicitation for a communication and independent of a request for, or processing a purchase of the service, wherein the offering comprises the service in a context of the registration profile as though the user searched for the service using the on-line account, wherein the offering comprises an indication that the user can purchase the service, receiving an indication from the user of a purchase of the service via an interaction with the offering, processing a payment for the service and through the on-line account and providing a merchant of the service, at the time of service via a fingerprint of the user, proof of purchase of the service through the on-line account.

The offering can include associating a coupon and the service. The method can include processing the payment including a rebate based on the coupon using the on-line account or registration profile. The offering can be based on a current service availability and the situation information of the user. The offering can be transmitted to the device of the user based on physical location of the user. The user can present an image to the merchant at the time of service as proof of purchase of the service. Such an image can be a security image or a UPC barcode or any image that is appropriate that the merchant would recognize.

A method can also include, based on a situation information of a user, associating, at a first time and via a processor, a service with (1) the user and (2) an existing registration profile that comprises a payment account of the user and a calendar of the user at an on-line account that processes purchasing services by the user, transmitting an offering to a device of the user, the transmitting being at a second time which is later than the first time, and the transmitting being independent of any user solicitation for a communication and independent of a request for, or processing a purchase of the service, wherein the offering comprises the service in a context of the registration profile as though the user searched for the service using the on-line account, wherein the offering comprises an indication that the user can purchase the service, receiving an indication from the user of a purchase of the service via an interaction with the offering including scheduling the service at an available time slot of a merchant of the service and processing a payment for the service through the on-line account.

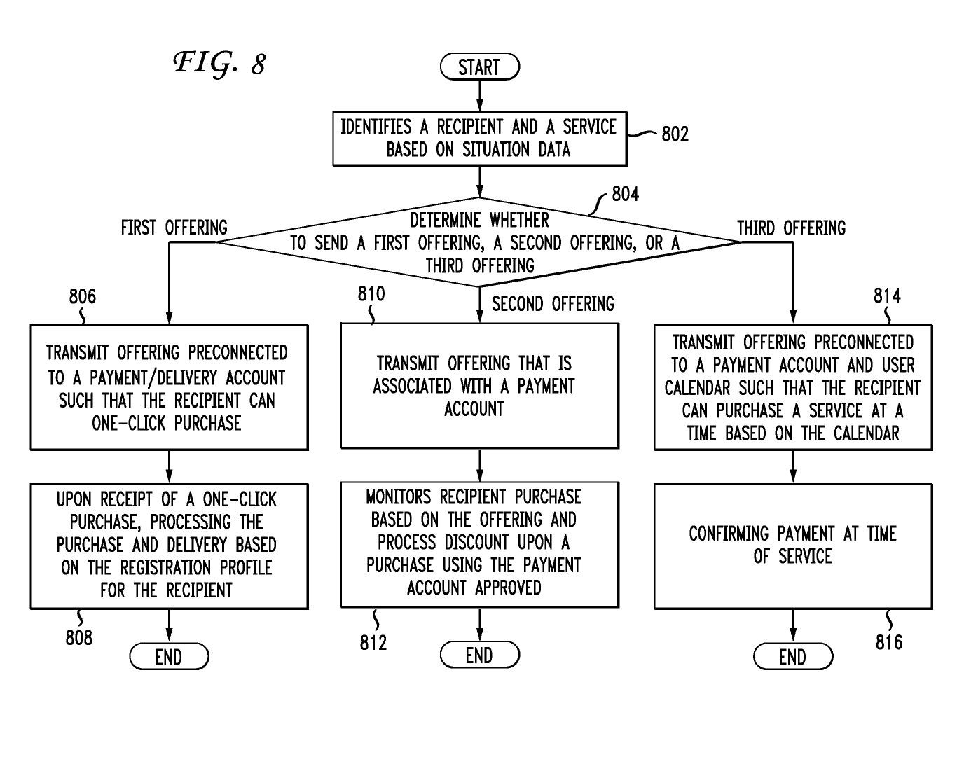

The third embodiment relates to making a determination of what type of offering to present to the user; a product offering, a service offering or another type of offering. Users do not want to be overwhelmed with offers. Therefore, it is important that the system select the appropriate type of offer. FIG. 8 illustrates the point. The first step involves identifying a recipient and a service based on situation data (802). The next step includes determining whether to send a first offering, a second offering or a third offering (804). If, for example the first offering is selected (a product offering), the system would transmit an offering pre-connected to a payment/delivery account such that the recipient can one-click purchase the product (806) and have it delivered. Next, upon receipt of the one-click purchase, the system processes the purchase and delivers the item based on the registration profile for the recipient (808). As an alternate option to step 804, the system can transmit a second offering that is pre-associated with a payment account (810). The system then can monitor as the recipient purchases based on the offering and processes a discount upon using the payment account approved (812). This second offering is the known approach. Next, step 804 can determine to send a third type of offering which is a service offering. The service offering can be associated with a calendar of at least one of the recipient and the merchant such that the sale of the service, the scheduling of the service (814), and confirming the payment at the time of providing the service can all be accomplished via the same single interaction with the offering (816).

The novelty presented with respect to FIG. 8 is that the system determines what type of offering to provide. One of a multitude of offerings can be what is identified in steps 806 and 814 in which the offering is pre-associated with or connected with the recipient's payment and delivery (and calendar) account, to enable the user to take no further steps than to perform a one-click acceptance of the offer.

Other options may also be available as a result of step 804. For example, one other offering option can be a simple advertisement that is not associated with a credit card, payment/delivery profile, or anything else. The different costs for these various offerings can be included in the determination as to what type of offering to send. This method embodiment involves making a determination based on a variety of factors of what type of offering to present to the user.

Another example of the method in FIG. 8 relates to location based situational information. In this case, a user may be physically near a Best Buy, Target or a restaurant. In this case, the determination step may conclude based on its algorithms that an offering in which the user can have a product delivered to their home is less desirable. The more desirable approach might be to present an offer that is associated with their credit card to entice them to come into a particular store and make a purchase. Therefore, the factors that go into determining which type of offer to present depend on the location of the user, purchasing history, information from various devices such as a car, home appliance and so forth. Many types of information are contemplated as being a part of the determination as to whether to send a product offer, a service offer or a credit card based offer as referenced in FIG. 8.

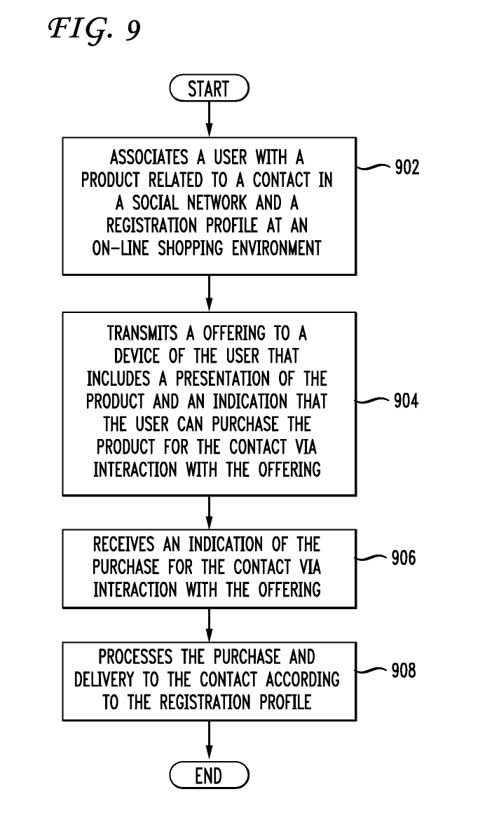

FIG. 9 illustrates an example method embodiment for one-click gift purchasing via a mobile device for a contact in a social network based on situation information of a user which includes information related to the contact. This is a fourth embodiment. Information related to the contact can include a shipping address, product and service preferences and important events. A system 100 configured to practice the method associates a user with a product related to a contact in a social network and a registration profile at an on-line shopping environment (902). A product can be a physical tangible object such as a book or a service such as a haircut. The registration profile includes a user payment account at the on-line shopping environment that manages the purchasing and shipping of the product to the contact. Additionally, the registration profile can link to a social network of the user having contacts and events associated with the contacts. Events associated with contacts in a social network can include birthdays, holidays, anniversaries, graduations and any other noteworthy events. The system transmits an offering to a device of the user that includes a presentation of the product and an indication that the user can purchase the product for the contact via interaction with the offering (904). The transmitting can occur at a later time than the associating and can be independent of any user solicitation for a communication and independent of a request for or processing a purchase of at least one product. The system receives an indication of the purchase for the contact via interaction with the offering (906) and the purchase is completed using the payment and delivery account in the registration profile (908). Interaction with the offering can include an option to purchase the product with one-click via a mobile device such as a smartphone using default purchase settings for the contact. The default purchase settings can include address information for the contact, credit card information for charging the purchase, gift wrap information and greeting information such as a standard greeting associated with an event. Alternately, the user can edit the default purchase settings to create a more personalized gift to the contact.

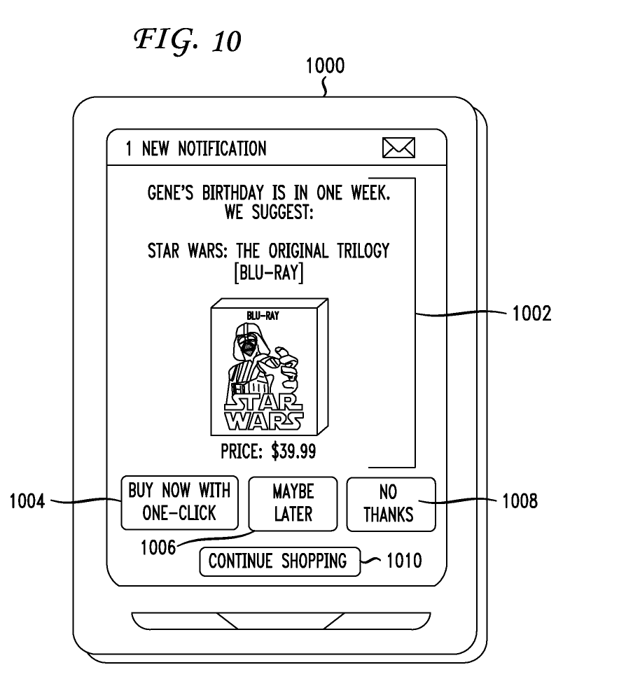

FIG. 10 illustrates an offering on a smartphone associated with a user, a contact in a social network and a registration profile for the user. The system associates a product such as the Star Wars DVD collection with the user, the contact in a social network and the registration profile of the user that includes the user payment account. The system can associate the Star Wars DVD collection with the contact based on prior purchases the contact or the user has made or in any other way for example based on web pages browsed by the contact at the on-line shopping environment. The system 100 can transmit an offering 1002 to a smartphone 1000 of the user that includes an offer for the user to purchase the product, in this case the Star Wars DVD collection for a contact in a social network related to the user. Based on situation information of the user, which includes a social network, the system presents an offering to the user to purchase the Star Wars DVD collection for Gene's birthday which will occur in one week. The user can purchase the gift for Gene using one-click by accepting the offer 1004, the user can wait on the purchase 1006 and the user can deny the offer 1008. The system can optionally re-offer the gift at a later time for the same or different price if the user clicked “MAYBE LATER” 1006 when offered to gift the collection. The system can complete the purchase using the payment account in the registration profile associated with the user.

As noted above, the system can also present a “CONTINUE SHOPPING” button 1010 option in which the user can continue to shop for similar items. In this case, because this is an offering of a suggested item for Gene's birthday which is coming up within a week, the “CONTINUE SHOPPING” 1010 option may be particularly tailored for the person for whom the gift is to be given. In other words, clicking on that option would not bring the user to a search result as though the user had searched for a Star Wars DVD. That type of search result would be somewhat limited. Although such a search result might be an optional feature, an alternate aspect would be to present a search result for items that would be of interest to people like Gene. If it is assumed that Gene's 12^{th} birthday is coming up in one week, the “continue shopping” button may present a variety of items that would give interest based on a category associated with the person. Thus, items would be items likely a 12 year old boy would be interested in for their birthday.

The user can complete the gift purchase using default purchase settings which include a default address for the contact, credit card information, gift wrap and a standard greeting related to the event. Optionally, the user can change the default settings for example the user can change the address of where to send the gift if the user knows the contact will be vacationing when the gift is scheduled to arrive. The user can choose to charge the purchase to a different credit card, for example if the default card is close to reaching its credit limit. The user can opt to include a personal greeting for Gene's birthday instead of the standard default birthday greeting. Allowing the user to gift a product to a contact in a social network via a mobile device using one-click provides an easy and efficient manner in which to send a gift to a friend without having to spend the time shopping, receiving, wrapping and delivering a gift. The entire process of gift-giving can be accomplished at the push of a button on a mobile device.

In one embodiment, the user can apply a coupon to the purchase of a gift for a contact in a social network for a discounted price or the system 100 can apply a rebate to the purchase account of the user for a subsequent purchase. The system can store one or more coupons related to the user and/or product(s) in the registration profile for later use. Optionally, the system can extend an offer to a user to purchase a particular gift for a contact in a social network based on stored coupons related to the user. For example, the system can choose the Star Wars DVD collection from a set of products associated with the user and a contact in a social network based on coupons available at a particular time. The system can send a message to the user offering the DVD collection and not another gift related to the contact because the user has a 10% off coupon that applies to DVD box sets at the on-line shopping environment and expires in one week. The same concept applies to rebates; the system can offer the DVD collection based on a rebate set to expire soon.

Additionally, the system 100 can present a product to the user to gift to a contact in a social network based on current product inventory and/or service availability. For example, the system can present the Star Wars DVD collection to gift to a contact because of an overstock.

The system 100 can optionally offer incentives to the user based on different factors such as gift purchase time, gift purchase date and contact event. For example, the system can offer a rebate on a future purchase if the user purchases a product and/or service by responding affirmatively to the offer provided on the mobile device. The system can offer $10 off a future purchase if the user purchases the suggested DVD collection for the contact in the user's social network in this example, Gene. Or the system can offer $5 off the suggested gift purchase if the purchase is completed within one week, prior to Gene's birthday. Offering incentives for situation based users via a mobile device using one-click purchasing and an on-line shopping environment can enhance the user's experience and encourage future purchases in the same manner, mutually benefitting the user and the merchant.

An offering could be in a message, email, tweet, instant message, text, audio broadcast, etc. The message could have a link which is configured to place a user in the position in the on-line shopping environment where it is as though the recipient had navigated to the environment, shopped for the product/service, and were positioned to be able to then, with one more interaction, purchase the item. The link could also position the user in the on-line environment where the product is one of a listing of comparable products in the on-line environment, i.e. one step before the ability to purchase by one-click. The user could view optional products/services, select and purchase desirable products/services, or place desired products/services in a shopping cart and continue shopping. The offering can be configured to place the recipient in any stage along the process of navigating through an on-line environment of the recipient during a shopping experience. The preferred embodiment is at the one-click purchasing stage, but other stages are contemplated as well and are included within the scope of the disclosure. In the case of an offering being in an audio broadcast, the listener can respond to the audio offering by stating “yes” or something else and the product could be bought and delivered.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps. Program modules may also comprise any tangible computer-readable medium in connection with the various hardware computer components disclosed herein, when operating to perform a particular function based on the instructions of the program contained in the medium.

Those of skill in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

Although the above description may contain specific details, they should not be construed as limiting the claims in any way. Other configurations of the described embodiments of the invention are part of the scope of this invention. For example, any type of service may be contemplated in the community of stores. For example, eye doctors and eye screening services, auto services, framing services, cleaning services, legal services, and so on. Any entity or company that provides services in which people are scheduled to arrive, may register or communicate via the internet or any other mechanism with an aspect of the present invention in which the time slots that become available can be matched with the various situation-based information associated with a user such that when a certain threshold is met, an offering can be transmitted to one or more users in order to efficiently fill in those open time slots. Furthermore, any point of sale scenario may be applicable to the principles herein. When the term “product” is used it is specifically meant to encompass any type of product or service. Similarly, in some cases, the term “service” may be used but can be interchangeable with the word product. Accordingly, unless the context is clearly defined as to what is meant, these terms are interchangeable. The user does not have to physically be at a store location but web-based sales, telephone call in sales where a user provides a card number, and so forth can all be tied into this system. Accordingly, the appended claims and their legal equivalents should only define the invention, rather than any specific examples given.

We claim:

1. A method comprising:
based on a situation information of a user, associating, at a first time and via a processor, a product with (1) the user and (2) an existing registration profile that comprises a payment account and a delivery address of an on-line shopping environment that processes purchasing and shipping of products to the delivery address;
transmitting an offering to a device of the user, the transmitting being at a second time which is later than the first time, and the transmitting being independent of any user solicitation for a communication and independent of a request for, or processing a purchase of the product, wherein the offering comprises the product in a context of the registration profile as though the user searched for the product using the on-line environment;
receiving an indication from the user of a purchase via an interaction with the offering; and
processing a payment for the product and delivery of the product to the delivery address through the on-line shopping environment.

2. The method of claim 1, wherein the offering further comprises associating a coupon with the product.

3. The method of claim 2, further comprising processing the payment including a rebate based on the coupon using the on-line shopping environment.

4. The method of claim 1, wherein the situation information of a user includes at least one of a location, a payment method and user preferences.

5. The method of claim 1, wherein the offering is based on a current product inventory and the situation information of the user.

6. The method of claim 1, wherein the interaction with the offering comprises an option to purchase the product with one-click using default purchase settings in the on-line shopping environment.

7. A system comprising:
a processor; and
a memory storing instructions for controlling the processor to perform a method comprising:
based on a situation information of a user, associating, at a first time and via a processor, a product with (1) the user and (2) an existing registration profile that comprises a payment account and a delivery address of an on-line shopping environment that processes purchasing and shipping of products to the delivery address;
transmitting an offering to a device of the user, the transmitting being at a second time which is later than the first time, and the transmitting being independent of any user solicitation for a communication and independent of a request for, or processing a purchase of the product, wherein the offering comprises the product in a context of the registration profile as though the user searched for the product using the on-line environment;
receiving an indication from the user of a purchase via an interaction with the offering; and
processing a payment for the product and delivery of the product to the delivery address through the on-line shopping environment.

8. The system of claim 7, wherein the interaction with the offering comprises an option to purchase the product with one-click using default purchase settings in the on-line shopping environment.

9. The system of claim 7, wherein the situation information of a user includes at least one of a location, a payment method and user preferences.

10. A non-transitory computer-readable storage medium storing instructions which, when executed by a computing device, cause the computing device to perform steps comprising:
based on a situation information of a user, associating, at a first time and via a processor, a product with (1) the user and (2) an existing registration profile that comprises a payment account and a delivery address of an on-line shopping environment that processes purchasing and shipping of products to the delivery address;
transmitting an offering to a device of the user, the transmitting being at a second time which is later than the first time, and the transmitting being independent of any user solicitation for a communication and independent of a request for, or processing a purchase of the product, wherein the offering comprises the product in a context of the registration profile as though the user searched for the product using the on-line environment;
receiving an indication from the user of a purchase via an interaction with the offering; and
processing a payment for the product and delivery of the product to the delivery address through the on-line shopping environment.

11. A method comprising:
based on a situation information of a user, associating, at a first time and via a processor, a product with (1) the user, (2) a contact and (3) an existing registration profile that comprises a payment account of the user and a delivery address of the contact at an on-line shopping environment that processes purchasing products by the user and shipping of products to the contact;
transmitting an offering to a device of the user, the transmitting being at a second time which is later than the first time, and the transmitting being independent of any user solicitation for a communication and independent of a request for, or processing a purchase of the product, wherein the offering comprises the product in a context of the registration profile as though the user searched for the product using the on-line shopping environment, wherein the offering comprises an indication that the user can purchase the product for the contact;
receiving an indication from the user of a purchase of the product for the contact via an interaction with the offering; and
processing a payment for the product and delivery of the product to the delivery address through the on-line shopping environment.

12. The method of claim 11, wherein the offering further comprises associating a coupon with the product.

13. The method of claim 11, further comprising processing the payment including a rebate based on the coupon using the on-line shopping environment.

14. The method of claim 11, wherein the situation information of a user includes at least one of a location, a payment method and user preferences.

15. The method of claim 11, wherein the offering is based on a current product inventory and the situation information of the user.

16. The method of claim 11, wherein the interaction with the offering comprises an option to purchase the product with one-click using default purchase settings in the on-line account.

17. The method of claim 11, wherein the contact is associated with the user via a social network.

18. The method of claim 11, wherein the existing registration profile stores information pertaining to the contact.

19. The method of claim 18, wherein information pertaining to the contact includes at least one of shipping address, product preferences and gift history.
